(19) United States
(12) Patent Application Publication
(10) Pub. No.: US 2015/0026483 A1
(43) Pub. Date: Jan. 22, 2015

(54) Systems and Methods for Mobile Application Protection

(71) Applicant: Marvell World Trade Ltd., St. Michael (BB)

(72) Inventors: Xin Jiang, Shanghai (CN); Jialin Chen, Shanghai (CN); Liangcai Li, Shanghai (CN); Xi Wu, Shanghai (CN); Jia Guo, Shanghai (CN)

(21) Appl. No.: 14/333,737

(22) Filed: Jul. 17, 2014

Related U.S. Application Data
(60) Provisional application No. 61/847,203, filed on Jul. 17, 2013.

(51) Int. Cl. G06F 21/12

(52) U.S. Cl. CPC G06F 21/12
USPC 713/190

(57) ABSTRACT

Systems and methods are provided for mobile application protection. An executable code associated with an application is received. An encrypted code and a wrapper code are generated based at least in part on the executable code. The encrypted code is capable of being decrypted based at least in part on the wrapper code. An application package including the encrypted code and the wrapper code is generated for a mobile device.

### CROSS-REFERENCE TO RELATED APPLICATIONS

This disclosure claims priority to and benefit from U.S. Provisional Patent Application No. 61/847,203, filed on Jul. 17, 2013, the entirety of which is incorporated herein by reference.

### FIELD

The technology described in this patent document relates generally to mobile devices and more particularly to mobile application protection.

### BACKGROUND

Mobile devices (e.g., smart phones) are often capable of supporting a great variety of applications (i.e., application software) to enrich user experience. A virtual machine (VM) usually corresponds to a software implementation of a computer that provides an independent programming environment for execution of one or more applications in a same way on any platform and abstracts away details of the underlying hardware or the Operating System (OS). A VM used in a mobile device may include, for example, a Java Virtual Machine (NM), an Android's Dalvik VM, a Low Level Virtual Machine (LLVM) used by Apples iPhone Operating System (iOS), etc, A VM may perform compiling to a bytecode to overcome constraints of a specific hardware or an OS, interpret a bytecode during an actual operation of an application, and execute the application. Applications developed for mobile devices are often distributed in an application package containing elements to run the application, such as program codes, resources, assets, certificates and manifest, For example, for an Android smart phone, an application package corresponds to an Application Package file (an APK file) of which a file name ends in “.apk.”

### SUMMARY

In accordance with the teachings described herein, systems and methods are provided for mobile application protection. An executable code associated with an application is received. An encrypted code and a wrapper code are generated based at least in part on the executable code. The encrypted code is capable of being decrypted based at least in part on the wrapper code. An application package including the encrypted code and the wrapper code is generated for a mobile device.

In one embodiment, a system for protecting applications for mobile devices includes: an encryption module and a package generator. The encryption module is configured to receive an executable code associated with an application and generate an encrypted code and a wrapper code based at least in part on the executable code. The encrypted code is capable of being decrypted based at least in part on the wrapper code. The package generator is configured to generate an application package including the encrypted code and the wrapper code for a mobile device.

In another embodiment, a system for protecting applications for mobile devices includes: one or more data processors and a machine readable storage medium. The storage medium is encoded with instructions for commanding the data processors to execute certain operations. An executable code associated with an application is received. An encrypted code and a wrapper code are generated based at least in part on the executable code. The encrypted code is capable of being decrypted based at least in part on the wrapper code. An application package including the encrypted code and the wrapper code is generated for a mobile device.

### BRIEF DESCRIPTION OF THE DRAWINGS

FIG. 1 depicts an example diagram showing an example packaging flow of an application for mobile devices.

FIG. 2 depicts an example diagram showing partial encryption of an application package.

FIG. 3 depicts an example diagram showing an example packaging flow of an application for mobile devices.

FIG. 4 depicts an example diagram showing another example packaging flow of an application fir mobile devices.

FIG. 5 depicts an example diagram showing signature checking of an application package.

FIG. 6 depicts an example diagram showing hash value checking of an application package.

FIG. 7 depicts an example flow chart for protecting applications for mobile devices.

### DETAILED DESCRIPTION

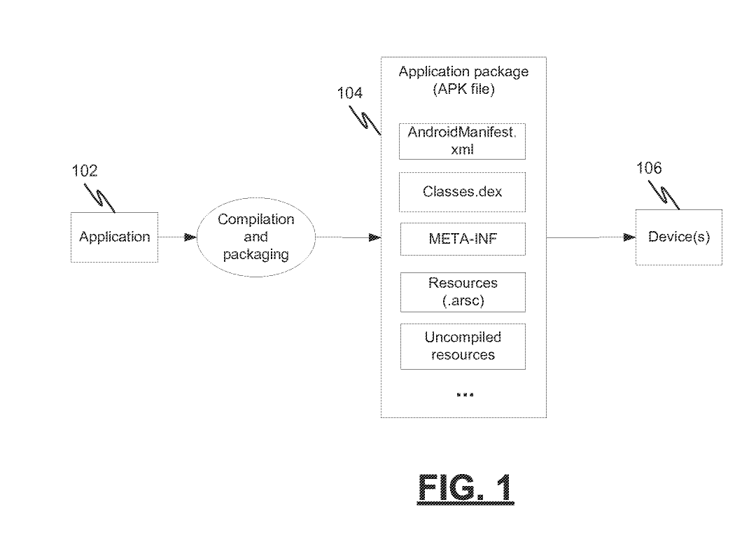

FIG. 1 depicts an example diagram showing an example packaging flow for an application for mobile devices. As shown in FIG. 1, the application 102 is compiled and packaged into an application package 104 that is then distributed to one or more mobile devices 106. Specifically, the application 102 is written in the Java language using the Android Software Development Kit (SDK). During compilation and packaging, the Java code is first compiled into class files in a Java bytecode format. Next, the class files are converted into DEX files in a Dalvik bytecode format, where the Dalvik bytecode corresponds to a native format for an Android's Dalvik VM. The application package (e.g., an APK file) 104 includes a manifest file (e.g., AndroidManifest.xml), executable codes (e.g., a classes.dex file), resources resources.arsc uncompiled resources, etc.

The application package 104 can often be easily de-compiled and tampered. Malware may be inserted into the application package 104, When the tampered application package 104 is run on the mobile devices 106, malicious operations may be carried out in the background to cause harm to the mobile devices 106. Thus, it is important to protect the application package 104 from being tampered.

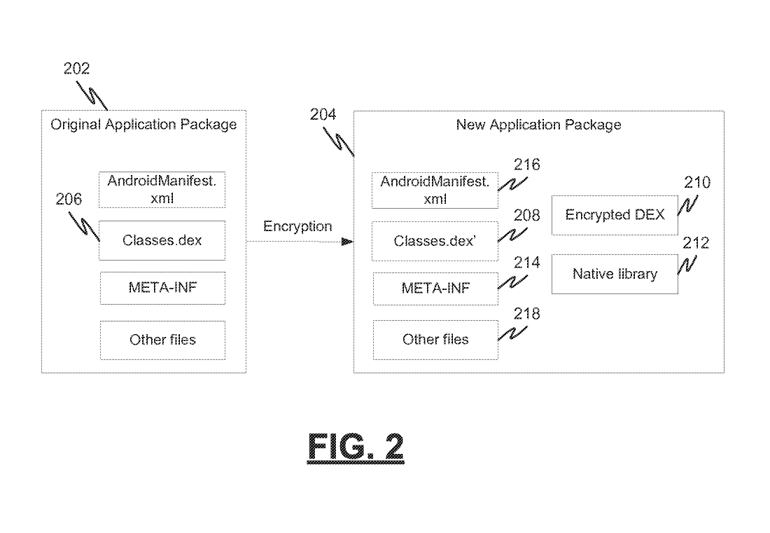

FIG. 2 depicts an example diagram showing partial encryption of an application package. As shown in FIG. 2, an original application package 202 is partially encrypted to generate a new application package 204. Specifically, an executable code 206 (e.g., a classes.dex file) associated with an application for mobile devices is converted into two files—an encrypted code 210 (e g., an encrypted DEX file) and a wrapper code 208 (e.g., a classes.dex′ file).

In some embodiments, the wrapper code 208 does not include an essential logic code for performing functions of the application. Instead, the essential logic code is encrypted and becomes part of the encrypted code 210 The wrapper code 208 is used to assist the decryption of the encrypted code 210 and invoke the essential logic code. A native library code 212 is used to support the wrapper code 208 (e.g., a classes.dex′ file) to load the encrypted code 210 (e.g., b a native secure class loader) and decrypt the encrypted code 210 in a memory of a target mobile device.

In certain embodiments, the new application package 204 includes a META-INF directory 214 that may contain a manifest file (e.g., “MANIFEST.MF”), a certificate (e.g., “CERT.RSA”), and a list of resources (e.g., “CERT.SF”). In addition, the new application package 204 includes an additional manifest file 21 (e.g., AndroidManifest.xml) that describes the name, version, access rights, and referenced library files for the application. The new application package 204 may chide other files 218, such as a “lib” directory that contains a compiled code specific to a software layer of a processor, a “resources.arsc” file that contains precompiled resources, directory that contains resources not compiled into the “resources.arsc” file, and an “assets” directory that contains applications assets.

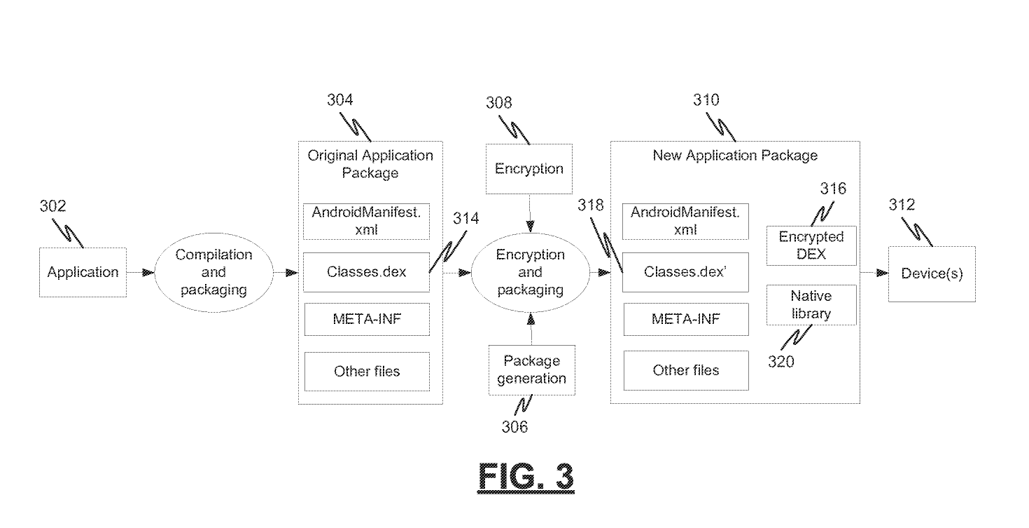

FIG. 3 depicts an example diagram showing an example packaging flow for an application for mobile devices. As shown in FIG. 3, the application 302 is compiled and packaged into an original application package 304, and the original application package 304 is partially encrypted to generate a new application package 310 that is then distributed to one or more mobile devices 312. An encryption component 308 performs the partial encryption of the original application package 304, and a package generator 306 generates the new application package 310. For example, the original application package 304 and the new application package 310 include same components as the original application package 202 and the new application package 204 respectively.

Specifically, the encryption component 308 converts an executable code 314 (e.g., a classes.dex file) into an encrypted code 316 (e.g., an encrypted DEX file) and a wrapper code 318 (e.g., a classes.dex' file). The wrapper code 318 does not include an essential logic code for performing functions of the application 308, and the essential logic code is contained in the encrypted code 316. A native library code 320 is used to support the wrapper code 318 to load the encrypted code 116 and decrypt the encrypted code 316 in a memory of the mobile devices 312. For example, the mobile devices 312 include mobile device emulators.

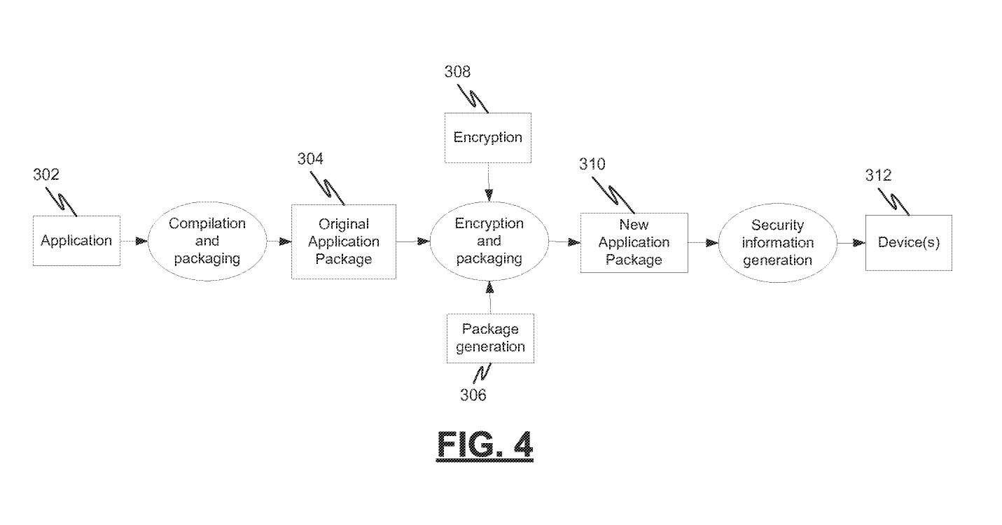

Security information may be generated for the new application package 310 for security verification, as shown in FIG. 4. Particularly, a signature or hash value(s) may be generated and stored in the new application package 310 for self-checking at a runtime stage.

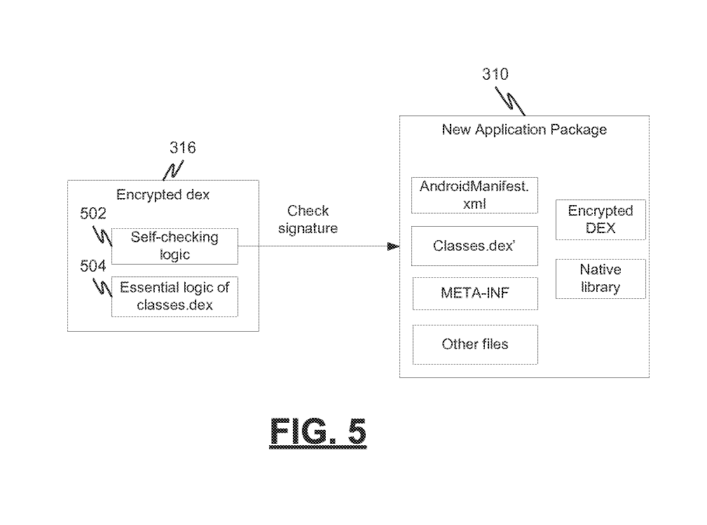

FIG. 5 depicts an example diagram showing signature checking of an application package. As shown in FIG. 5, a self-checking logic code 502 within the encrypted code 316 is used to check a signature of the new application package 310 at a runtime stage (e.g., on a mobile device). Specifically, the self-checking logic code 502 includes information associated with an original signature. The self-checking logic code 502 is invoked (e.g., for a runtime process of the application 302) to verify the signature of the new application package 310. If the self-checking logic code 502 determines that the signature of the new application package 310 is not authentic, the signature checking fails, which indicates that the new application package 310 is tampered, and certain measures may be taken in response. For example, a notification is generated to issue a warning, and/or a runtime process associated with the application 302 is terminated.

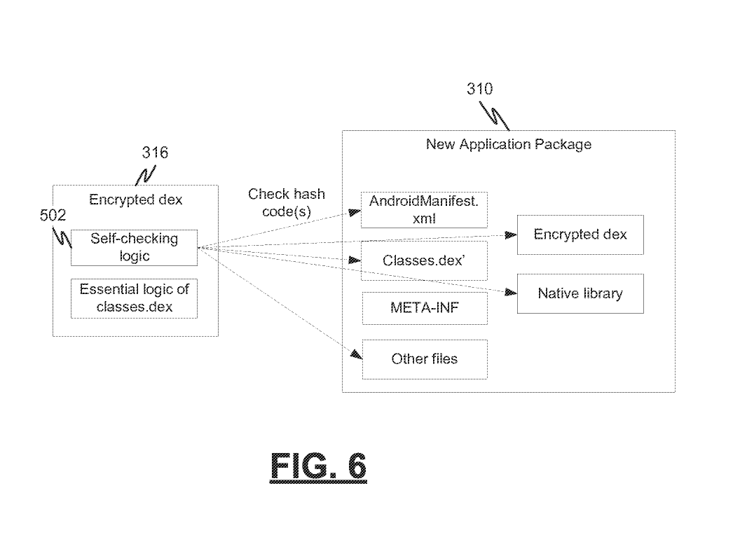

FIG. 6 depicts an example diagram showing hash value checking of an application package. As shown in FIG. 6, the self-checking logic code 502 within the encrypted code 316 is used to check one or more hash values related to one or more files (e.g., codes) of the new application package 310 at a runtime stage (e.g., on a mobile device). Specifically, the self-checking logic code 502 includes information associated with one or more hash values related to one or more files (e.g., codes) of the new application package 310. The hash values are generated by mapping data in the files (e.g., codes) through any proper hash function or hash algorithms. For example, multiple hash values are generated corresponding to different files within the application package 310. A single hash value may be generated for the application package 310. Any changes/modifications to the data of the files (e.g., codes) can be determined by comparison of related hash values.

The self-checking logic code 502 is invoked (e.g., for a runtime process of the application 302) to verify the hash values of one or more files (e.g., codes) of the new application package 310. If the self-checking logic code 502 determines that the hash values are not authentic, the hash value checking fails, which indicates that the new application package 310 is tampered, and certain measures may be taken in response. For example, a notification is generated to issue a warning, and/or a runtime process associated with the application 302 is terminated.

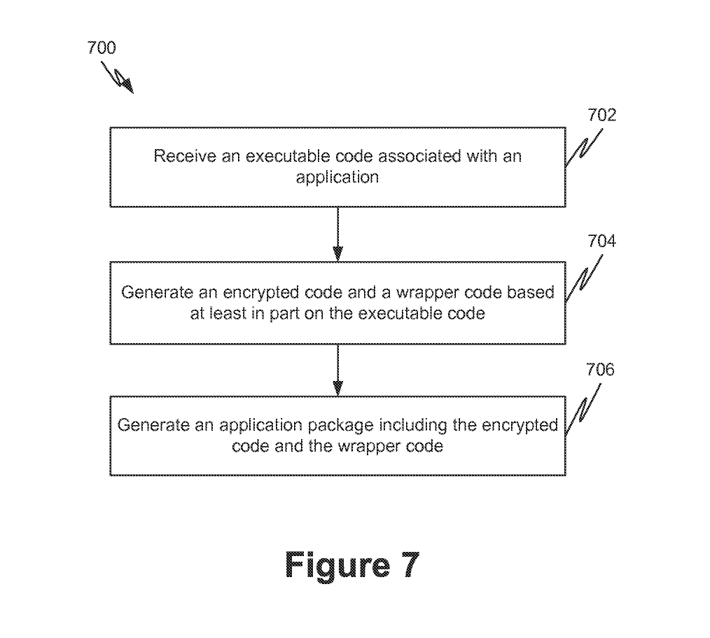

FIG. 7 depicts an example flow chart for protecting applications for mobile devices. As shown in FIG. 7, at 702, an executable code associated with an application is received. At 704, an encrypted code and a wrapper code are generated based at least in part on the executable code. The encrypted code is capable of being decrypted based at least in part on the wrapper code. At 706, an application package including the encrypted code and the wrapper code is generated for a mobile device.

This written description uses examples to disclose the invention, include the best mode, and also to enable a person skilled in the art to make and use the invention. The patentable scope of the invention may include other examples that occur to those skilled in the art. Other implementations may also be used, however, such as firmware or appropriately designed hardware configured to carry out the methods and systems described herein. For example, the systems and methods described herein may be implemented in an independent processing engine, as a co-processor, or as a hardware accelerator. In yet another example, the systems and methods described herein may be provided on many different types of computer-readable media including computer storage mechanisms (e.g., CD-ROM, diskette, RAM, flash memory, computer's hard drive, etc.) that contain instructions (e.g., software) for use in execution by one or more processors to perform the methods' operations and implement the systems described herein.

What is claimed is:

1. A method for protecting applications for mobile devices, the method comprising:
receiving an executable code associated with an application;
generating an encrypted code and a wrapper code based at least in part on the executable code;
wherein the encrypted code is capable of being decrypted based at least in part on the wrapper code; and
generating an application package including the encrypted code and the wrapper code for a mobile device.

2. The method of claim 1, wherein the encrypted code includes an essential logic code for performing functions of the application.

3. The method of claim 1, wherein the wrapper code is used to invoke the essential code.

4. The method of claim 1, wherein the application package corresponds to an APK file associated. with an Android operating system.

5. The method of claim 1, wherein the application package further includes a native library code for loading the encrypted code.

6. The method of claim I, wherein the encrypted code includes a self-testing logic code for security verification of the application.

7. The method of claim 6, wherein:
the application package further includes a signature; and
the self-testing logic code is capable of verifying the signature.

8. The method of claim 6, wherein:
the application package further includes a hash value; and
the self-testing logic code is capable of verifying the hash value.

9. The method of claim 6, wherein a notification is generated in response to failure of the security verification.

10. The method of claim 6, wherein a runtime process associated with the application is terminated in response to failure of the security verification.

11. A system fur protecting applications for mobile devices, the system comprising:
an encryption module configured to receive an executable code associated with an application and generate an encrypted code and a wrapper code based at least in part on the executable code;
wherein the encrypted code is capable of being decrypted based at least in part on the wrapper code; and
a package generator configured to generate an application package including the encrypted code and the wrapper code for a mobile device.

12. The system of claim 11, wherein the encrypted code includes an essential logic code for performing functions of the application.

13. The system of claim 12, wherein the wrapper code is used to invoke the essential code.

14. The system of claim 11, wherein the application package corresponds to an APK file associated with an Android operating system.

15. The system of claim 11, wherein the application package further includes a native library code for loading the encrypted code.

16. The system of claim 11, wherein the encrypted code includes a self-testing logic code for security verification of the application.

17. The system of claim 16, wherein:
the application package further includes a signature; and
the self-testing logic code is capable of verifying the signature.

18. The system of claim 16, wherein:
the application package further includes a hash value of a file; and
the self-testing logic code is capable of verifying the hash value.

19. The system of claim 16, wherein:
when the security verification fails, a notification is generated or a runtime process associated with the application is terminated.

20. A system for protecting applications for mobile devices, the system comprising:
one or more data processors; and
a machine readable storage medium encoded with instructions for commanding the data processors to execute operations including:
receiving an executable code associated with an application;
generating an encrypted code and a wrapper code based at least in part on the executable code;
wherein the encrypted code is capable of being decrypted based at least in part on the wrapper code; and
generating an application package including the encrypted code and the wrapper code for a mobile device.
